(19) United States
(12) Patent Application Publication
(10) Pub. No.: US 2013/0303237 A1
(43) Pub. Date: Nov. 14, 2013

(54) ELECTRIC SHOCKER

(71) Applicants: Alon Naor Guest, Tel Aviv (IL); Tomer Menahem, Modi'in (IL); Ofer Ohayon, Modi'in (IL); Avihu Sasson, Kfar Saba (IL)

(72) Inventors: Alon Naor Guest, Tel Aviv (IL); Tomer Menahem, Modi'in (IL); Ofer Ohayon, Modi'in (IL); Avihu Sasson, Kfar Saba (IL)

(21) Appl. No.: 13/803,254

(22) Filed: Mar. 14, 2013

Related U.S. Application Data
(60) Provisional application No. 61/646,303, filed on May 13, 2012.

(51) Int. Cl. H04M 1/02

(52) U.S. Cl. CPC H04M 1/026
USPC 455/556.1

(57) ABSTRACT

An electric shocker including a body sized and shaped to receive a cellular phone, an adapter plug, complementary to a socket in the cellular phone, mounted in the body, a pair of contacts adjacent to one another protruding from an outside surface of the body, a battery in the body, an electric circuit electrically coupling the battery to the contacts, the electric circuit including electric components for creating a high potential drop across the contacts, and an activation switch in the body for selectably activating the electric circuit.

### FIELD OF THE INVENTION

The present invention relates to protection devices, in general and, in particular, to an electric shocker.

### BACKGROUND OF THE INVENTION

With the advent of cellular phones, many people carry cell phones with them everywhere, in close proximity for convenient and fast access. Due to the sensitivity of many of their components, cellular phones typically are enclosed in protective cases, at least when traveling. Thus, protective covers for cellular phones of varying designs are well known. These are typically formed of silicone or leather or other shock absorbing material and serve to protect the phone against shock or breakage, if the phone should fall onto a hard surface.

As cellular phones become more and more expensive, the number of people who are held-up or robbed of their cellular phones is on the rise. Thus, even in the case of a robbery, the victim's cellular phone is easily accessible and he or she is able or encouraged to hand the phone to the assailant.

In addition, there are many occasions on which it is helpful to have a handy means for self-defense. There are known a variety of devices that hold chemical deterrents and many which deliver an electric shock to an attacker. These devices are typically stand-alone devices.

Accordingly, there is a long felt need for an easily accessible electric shock device that can be carried and produced without suspicion in case of an attack, or that would even be demanded by the attacker.

### BRIEF DESCRIPTION OF THE DRAWINGS

The present invention will be further understood and appreciated from the following detailed description taken in conjunction with the drawings in which:

FIG. 1 is a schematic illustration of the front of an electric shocker constructed and operative in accordance with one embodiment of the present invention;

FIG. 2 is a schematic illustration of the rear of the electric shocker of FIG. 1;

FIG. 3 is a schematic block diagram illustration of a shocker circuit, according to one embodiment of the invention; and

FIGS. 4a and 4b are schematic illustrations of the front and rear, respectively, of an exemplary design for an electric shocker with a cellular phone mounted therein.

### SUMMARY OF THE INVENTION

The present invention relates to a self-defense shocker device embodied in a cellular phone protective cover. In particular, the shocker device can be connected for communication to the cellular phone held therein, in order to provide emergency notification in case of activation of the shocker.

There is, thus, provided, according to the present invention, an electric shocker including a body sized and shaped to receive a cellular phone, an adapter plug, complementary to a socket in the cellular phone, mounted in the body, a pair of contacts adjacent to one another protruding from an outside surface of the body, and a battery in the body. The electric shocker also includes an electric circuit electrically coupling the battery to the contacts, the electric circuit including electric components for creating a high potential drop across the contacts, and an activation switch in the body for selectably activating the electric circuit.

According to exemplary embodiments of the invention, the shocker further includes a controller in the body coupled to a communication device for communication with a controller in the cellular phone.

Preferably, the shocker further includes a safety switch for preventing operation of the activation switch.

According to exemplary embodiments of the invention, the shocker further includes an electric circuit coupling the shocker battery to a cellular phone in the shocker body, whereby the shocker battery can be coupled selectively to the cellular phone battery to serve as a back-up power source for the cellular phone.

There is further provided, according to the invention, a protective case for a cellular phone, the case including a body sized and shaped to receive a cellular phone, an adapter plug, complementary to a socket in the cellular phone, mounted in the body and an electric shocker disposed in the body. The electric shocker includes a pair of contacts adjacent to one another protruding from an outside surface of the body, a shocker battery in the body, an electric circuit electrically coupling the shocker battery to the contacts, the electric circuit including components creating a high potential drop across the contacts, and an activation switch in the body for selectably activating the electric circuit.

There is also provided, according to the invention, a method of providing an electric shock, the method including forming a body sized and shaped to receive a cellular phone, mounting a pair of contacts adjacent to one another on an outside surface of the body, mounting a shocker battery in the body, electrically coupling the shocker battery to the contacts by an electric circuit disposed in the body, the electric circuit including components creating a high potential drop across the contacts, and selectably activating the electric circuit.

### DETAILED DESCRIPTION OF THE INVENTION

The present invention relates to an electric shocker, shaped like the case of a cellular phone, that can be used as a stand-alone item or as a case in which a cellular telephone can be seated for protection against scratching and breakage. The shocker is configured for attachment to a cellular phone. In some embodiments, the shocker includes a communications unit that provides two-way communication between the shocker and the cellular phone, and can affect or direct the operation of the cell phone. In other embodiments, the shocker is a stand-alone device that has no effect on the operation of the cell phone.

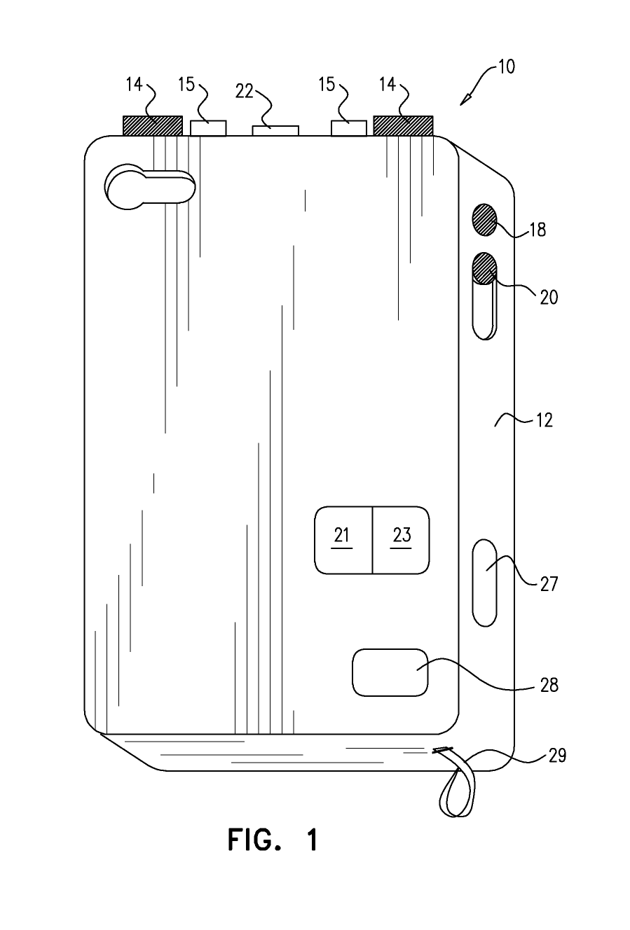

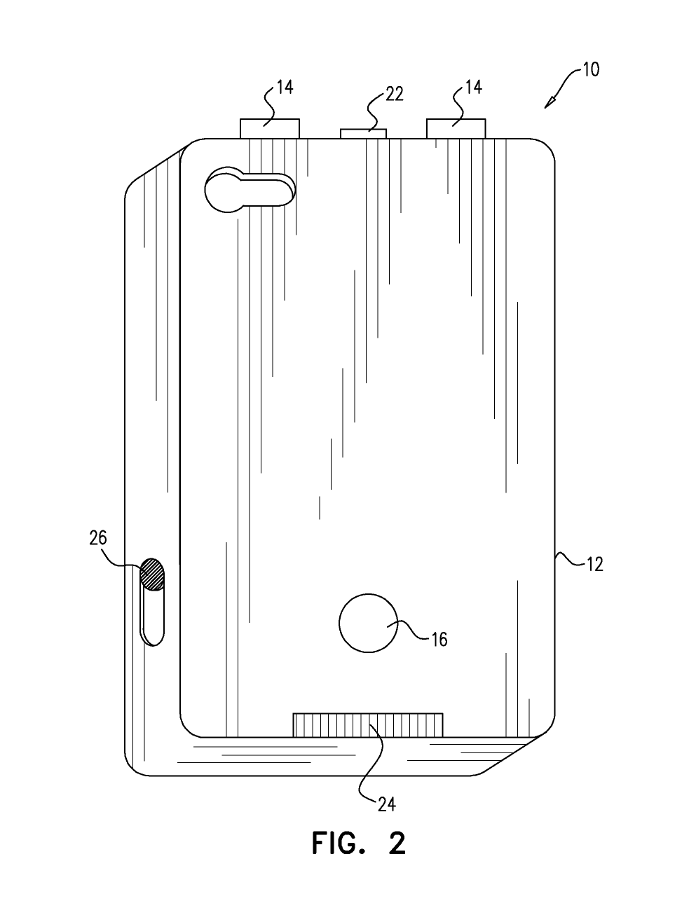

Referring to FIGS. 1 and 2, there are shown respective front and rear schematic views of a shocker 10 constructed and operative according to one embodiment of the invention. The shocker 10 has a body 12 having a shape of a cellular phone case, e.g., complementary to a cellular phone (not shown), with a pair of contacts 14 adjacent to one another protruding from an outside surface of the body. Preferably, the body 12 is formed of an electrically insulating material, for example, silicon, or rubber, so as not to damage a cell phone seated inside it or a user holding it when the shocker is activated. Preferably, this material is also shock absorbing, so as to cushion a cell phone seated therein if it falls.

Preferably, a mirror 15 or other reflector is disposed adjacent contacts 14. When the shocker is activated, as described below, and a spark is created between contacts 14, the mirror 15 will reflect the light towards the attacker, making the light appear brighter than it is.

In addition or alternatively, a shocker speaker 28 can be provided, for example, built-in in the shocker body 12. Shocker speaker 28 can be provided with an electric component for generating an alarm signal to emit an alarm noise when the shocker is activated.

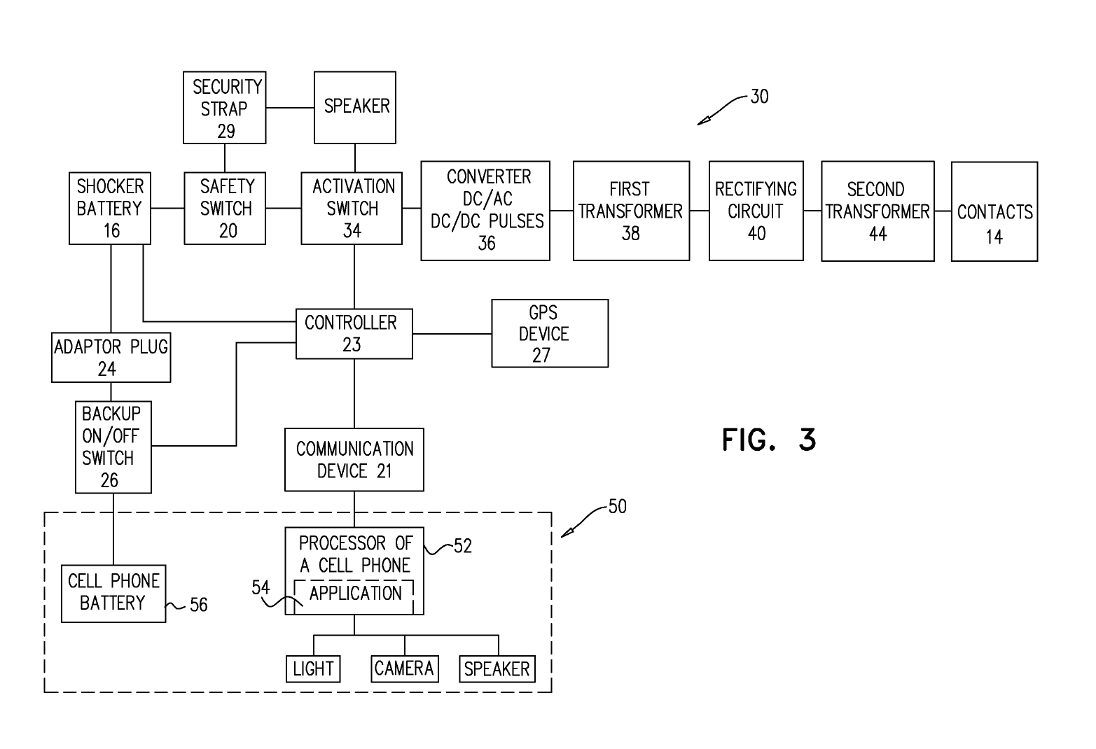

A battery 16 for the shocker is mounted in the body 12 for powering all the electric components of the shocker. An electric circuit, such as that illustrated by way of example only in FIG. 3, including a transformer or other voltage multiplier coupling the battery to the contacts, is also mounted in body 12. An activation (on/off) switch 18 is provided in a side of the body for selectably closing the circuit to create a potential difference across the contacts 14, which causes an electric shock when the contacts are electrically connected. The activating switch may be covered with silicon or other material requiring the user to apply force in order to activate the activation switch, so as to prevent children from actuating the shocker.

A safety switch 20, to ensure that the shocker is activated only intentionally, is also provided in the side of the body. Preferably, the safety switch 20 requires both a sliding and a pressing motion in order to prevent inadvertent activation of the shocker. Safety switch 20 prevents creation of a potential drop across the contacts when the shocker is not in use and prevents inadvertent activation of the circuit by inadvertent pressing of the activation switch 18. Release of safety switch 20 moves the circuit to an active state before activation. Most preferably, a signal will be provided on the body or on the cell phone when the safety switch has been switched off (i.e., the circuit can be activated). The signal can be a visible signal, such as a light, an audible signal and/or a tactile signal, such as vibration, etc.

In addition, a security strap 29 may be provided, for example, extending through the base of the shocker, coupled to the safety switch and to alarm circuitry in the body 12. Security strap 29 is configured to be coupled to a belt loop, shoulder strap, etc. of the phone owner. In case the phone is taken by force from the user, or the strap is opened without permission, the security strap 29 will lock the safety switch to prevent the creation of an electric shock in the shocker when the activation switch is pushed. In this way, the shocker cannot be used against the phone's owner, even if the case, with or without the phone in it, is stolen from him. In addition, removal of the security strap 29 will activate alarm circuitry in the shocker, which will cause a warning alarm to sound through speaker 28.

A camera 22 may be provided in shocker 10, having a lens on the body between the contacts, for taking a picture of an attacker. Preferably, actuating the activation switch 18 would create a shock and simultaneously activate the camera 22 and the speaker 28.

According to some embodiments of the invention, the shocker further includes a communication device 21 for two-way communication between the shocker and a cellular phone mounted in the body. Communication device 21 may include an adapter plug 24 or strip of contacts, arranged to engage a connector slot or jack in a cellular phone, seated in the body of the shocker, or blue tooth circuitry, for communication with blue tooth circuitry inside the cellular phone, or any other wireless or other communication means.

If desired, a geographic location device 27, such as a GPS (Global Positioning System) receiver may be provided in the shocker for permitting monitoring of the location of the shocker. Alternatively, the shocker can utilize the geographic location device inside the cellular phone mounted in the shocker.

A controller 23 (described in detail below with reference to FIG. 3) is provided in body 12 to control the operation of the various components in the shocker, preferably on a chip or integrated circuit. The controller 23 includes computer program instructions or circuitry for activating the camera 22 and speaker 28 in the shocker and for receiving geographical indication signals. Controller 23 also monitors the level of power in the battery 16 and provides an output signal corresponding thereto. This signal may go to a LED or display to indicate to the user the level of power in the battery and when re-charging is required. The controller 23 also actuates communication device 21 to send commands or other signals to the processor in the cellular phone, when a cellular phone is mounted in the shocker.

In this way, the cellular phone can be programmed to command the cellular phone to dial an emergency phone number, for example, and/or send a pre-drafted short message (SMS) and/or activate a remote device and/or send GPS coordinates, when the activation button is pressed. When the shocker includes a camera 22, the controller can be programmed to save the pictures automatically, and prevent erasure of the pictures except by entry of a personal code. These pictures can be sent, via the communication device, to a memory in the cell phone and/or to a pre-selected recipient or destination. Another option is to cause the cellular phone to emit an emergency alarm through its own speaker when the shocker is activated. This alarm could be one of the tones in the phone, such as a wake up alarm, emitted at high volume.

As described above, in some embodiments, the body further includes an adapter plug 24 or strip of contacts, arranged to engage a connector slot or jack in a cellular phone. In this case, electric circuitry is provided between the shocker and the phone designed so that the battery of the shocker can serve as a backup battery for the cellular phone, when required. A backup on/off switch 26 is provided in that electric circuitry for closing the circuit to cause the shocker battery 16 to power the recharge the battery of the cellular phone when the cellular phone's battery is low. Backup switch 26 preferably is actuated manually by the user. An indicator sound or light may be activated to indicate that the phone is operating on backup power. Preferably, the controller in the shocker monitors the level of power in the shocker battery and is configured to activate the backup switch to automatically disconnect the shocker battery from the phone battery to stop cellular phone charging when the shocker battery reaches a pre-defined energy level. This pre-defined level is selected so as to retain, at all times, sufficient energy in the battery to power the shocker circuit and, preferably, to permit an emergency call or SMS as well.

It will be appreciated that a computer program application including computer readable instructions for coordinating with the shocker controller can be provided for downloading to the cellular phone and storage in a non-volatile memory of the cellular phone. This application can be downloaded from a web site associated with the shocker, from a memory device sold with the shocker, or can be stored in the controller of the shocker for automatic uploading to the cellular phone when the phone is connected to the shocker. This application would connect components of the phone to the controller of the shocker via the communication device in the shocker body, to cause the cellular phone to perform at least one of a number of pre-defined operations, including dialing a predefined phone number, sending an SMS text message to a preselected address, activation of an alarm tone or flashlight in the phone, and so on.

Referring now to FIG. 3, there is shown an exemplary embodiment of an electric circuit 30 for a shocker, according to some embodiments of the invention. Circuit 30 includes a shocker battery 16. Battery 16 may be a button cell, AAA batteries, a rechargeable battery or batteries (e.g., Lithium), or any other type of battery of suitable size to fit in the case, as desired. An activation switch 34 is provided in circuit 30. Preferably, a safety switch 20 is provided so that activation switch 34 will not be activated inadvertently. The battery 16 is coupled via the activation switch 34 to a DC to AC converter or a DC to DC pulse converter 36 which, in turn, provides AC current or DC pulses to a transformer 38. The transformer doubles or triples the voltage, for example, to between about 400 and 1200 volts. The transformer 38 feeds a rectifying circuitry 40 consisting of one or more diodes and a rectifying capacitor which rectifies the AC current or DC pulse current supplied by the transformer, and doubles or triples it. This multiplied high voltage charges the capacitor. When the voltage in the charged capacitor reaches a threshold, a spark is created across a gap between the capacitor and a second transformer 44, which creates a short-duration pulse. This pulse is fed to the primary coil of transformer 44, where the voltage is raised again and transferred to the secondary coil of transformer 44, which is electrically coupled to contacts 14. When the activation switch 34 is pressed, pulses are created repeatedly, as long as the activation switch 34 is in the on position. The winding ratio of the second transformer 44 can range from 1:50 to 1:500. In this way, the voltage of the pulses can be raised as desired. The frequency of pulses determines the amount of current at the shock contacts and, therefore, the intensity of the shock.

As can be seen, the shocker controller 23 is coupled via communication device 21 to the controller or processor 52 of a cellular phone 50 mounted in the shocker 10. In this way, control commands and signals indication actuation of the activation switch and, thus, use of the shocker, can be transferred to the processor 52 of phone 50. In this way, commands from the shocker controller 23 can cause an application 54 in the processor 52 to perform one or more pre-defined tasks. In addition, shocker battery 16 is coupled via backup on/off switch 26 to the cellular phone battery 56 for charging the cellular phone battery 56, as described above.

If desired, a warning light (when a phone is mounted in the shocker) or a loud alarm may be activated simultaneously with pressing the activation switch on the shocker. Preferably, inputting a code is required in order to turn off the alarm, so as to prevent an attacker from turning off the alarm. It will be appreciated that this is only possible when a cell phone is in the body.

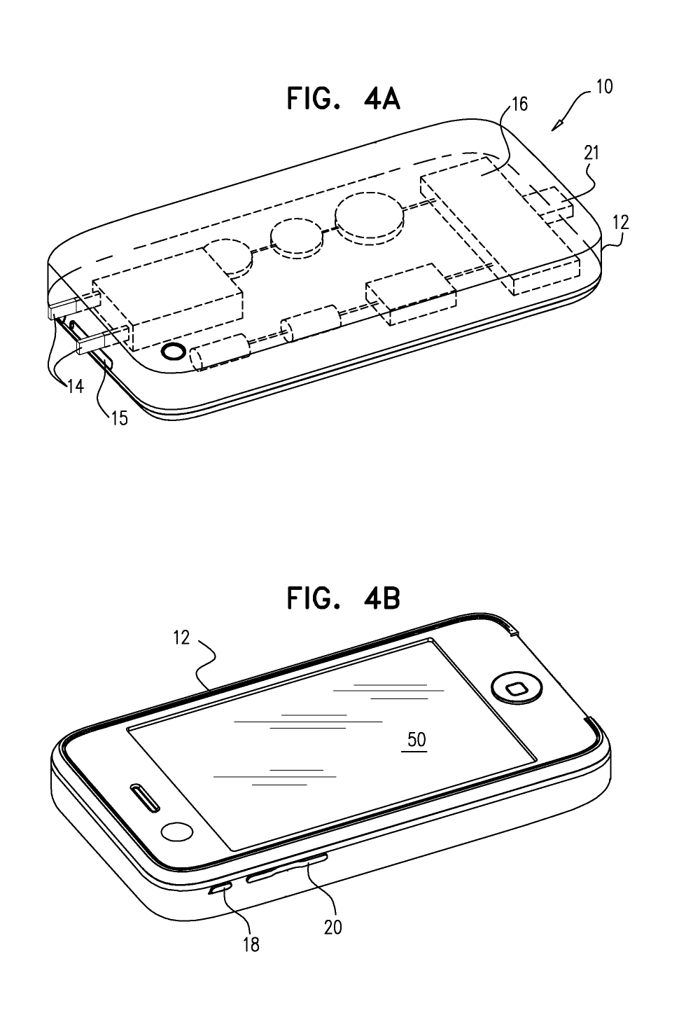

FIGS. 4a and 4b are schematic illustrations of the front and rear, respectively, of an exemplary, ergonomic design for an electric shocker, illustrated with a cellular phone mounted therein.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. An electric shocker comprising:
a body sized and shaped to receive a cellular phone;
an adapter plug, complementary to a socket in said cellular phone, mounted in said body;
a pair of contacts adjacent to one another protruding from an outside surface of said body;
a battery in said body;
an electric circuit electrically coupling said battery to said contacts, said electric circuit including electric components for creating a high potential drop across said contacts; and
an activation switch in said body for selectably activating said electric circuit.

2. The electric shocker according to claim 1, further comprising a controller in said body coupled to a communication device for communication with a controller in the cellular phone.

3. The electric shocker according to claim 1, further comprising a safety switch for preventing operation of said activation switch.

4. The electric shocker according to claim 1, further comprising:
a speaker mounted in said body; and
an alarm circuit connected to said electric circuit for activating said speaker to sound an alarm.

5. The electric shocker according to claim 3, further comprising a safety strap coupled to a switch in said body, said switch configured to lock said safety switch and activate an alarm when pulled from the shocker.

6. The electric shocker according to claim 1, further comprising an electric circuit coupling said battery to a cellular phone in said shocker body, whereby said shocker battery can be coupled selectively to said cellular phone to serve as a back-up power source for said cellular phone.

7. The electric shocker according to claim 2, further comprising computer readable instructions for downloading to the cellular phone and storage in a non-volatile memory of the cellular phone to connect components of the phone to the communication device in the shocker body, to perform at least one of: dialing a predefined phone number, sending an SMS text message to a preselected address, activation of an alarm tone or flashlight in the phone, or measuring power remaining in said shocker battery.

8. A protective case for a cellular phone, the case comprising:
a body sized and shaped to receive a cellular phone;
an adapter plug, complementary to a socket in said cellular phone, mounted in said body;
an electric shocker disposed in said body, said electric shocker including:
a pair of contacts adjacent to one another protruding from an outside surface of said body;
a shocker battery in said body;
an electric circuit electrically coupling said battery to said contacts, said electric circuit including components creating a high potential drop across said contacts; and
an activation switch in said body for selectably activating said electric circuit.

9. A method of providing an electric shock, the method comprising:
forming a body sized and shaped to receive a cellular phone;
mounting a pair of contacts adjacent to one another on an outside surface of said body;
mounting a shocker battery in said body;
electrically coupling said battery to said contacts by an electric circuit disposed in said body, said electric circuit including components creating a high potential drop across said contacts; and
selectably activating said electric circuit.

10. The method according to claim 9,
wherein said step of forming includes mounting a shocker controller in said body; and
further comprising:
sending control commands by said controller to a controller of a cellular phone mounted in said body, to cause said cellular phone controller to perform at least one of: dialing a predefined phone number, sending an SMS text message to a preselected address, activation of an alarm tone or flashlight in the phone.

11. The method according to claim 9,
wherein said step of forming includes mounting a shocker controller in said body; and
further comprising:
monitoring a level of power is said shocker battery by said shocker controller and providing an output signal corresponding thereto.
